(19) United States
(12) Patent Application Publication
(10) Pub. No.: US 2026/0337094 A1
(43) Pub. Date: Oct. 29, 2026

(54) LOW-BORON-CONTENT HIGH-PERFORMANCE ALKALI-FREE GLASS FIBER COMPOSITION

(71) Applicant: TAISHAN FIBERGLASS ZOUCHENG CO., LTD., Jining (CN)

(72) Inventors: Lifeng LIU, Jining (CN); Feng Zhang, Jining (CN); Chao Yang, Jining (CN); Yundong Sun, Jining (CN); Jiafang Wang, Jining (CN); Qiang Fang, Jining (CN); Wei Li, Jining (CN); Gang Li, Jining (CN); Guodong Liu, Jining (CN); Cong Ding, Jining (CN); Wenfeng Yang, Jining (CN); Kun Wang, Jining (CN)

(73) Assignee: TAISHAN FIBERGLASS ZOUCHENG CO., LTD., Jining (CN)

(21) Appl. No.: 19/560,241

(22) Filed: Mar. 9, 2026

Related U.S. Application Data
(63) Continuation of application No. PCT/CN2025/105282, filed on Jun. 30, 2025.

(30) Foreign Application Priority Data
Apr. 25, 2025 (CN) 202510529635.9

(51) Int. Cl. C03C 13/00; C03C 3/118

(52) U.S. Cl. CPC C03C 13/00; C03C 3/118

(57) ABSTRACT

A low-boron-content high-performance alkali-free glass fiber composition is provided The low-boron-content high-performance alkali-free glass fiber composition includes the following components in mass percentages: 52% to 60% of SiO₂, 11% to 15% of Al₂O₃, 2% to 6% of B₂O₃, 18% to 25% of CaO, 1% to 3% of MgO, 0.1% to 0.6% of Fe₂O₃, 0.1% to 2.5% of TiO₂, 0.3% to 0.6% of a fluoride, 0.05% to 0.75% of K₂O, 0.05% to 0.75% of Na₂O, and 0.1% to 3% of XO, where the XO includes one or more of FeO, SeO₂, BeO, La₂O₃, and CeO₂. While reducing the boron content, the provided adjusts the glass composition to ensure the stability of melting and forming conditions of the glass fiber composition without compromising the performance of a product of the glass fiber composition, and to enable the improved light transmittance and the reduced dielectric constant.

### CROSS REFERENCE TO THE RELATED APPLICATIONS

This application is a continuation application of International Application No. PCT/CN2025/105282, filed on Jun. 30, 2025, which is based upon and claims priority to Chinese Patent Application No. 202510529635.9, filed on Apr. 25, 2025, the entire contents of which are incorporated herein by reference.

### TECHNICAL FIELD

The present disclosure relates to the technical field of glass fibers, and specifically relates to a low-boron-content high-performance alkali-free glass fiber composition.

### BACKGROUND

Alkali-free glass, also known as E-glass, typically refers to silicate glass with an alkali metal content of no more than 0.8%. Alkali-free glass fibers originated in the mid-20th century. Alkali-free glass fibers have been widely used in composites and electrical insulation due to high strength and outstanding chemical stability. However, the traditional manufacturing process of alkali-free glass involves a high boron content. Boron-containing raw materials primarily rely on imports, resulting in increased costs. Additionally, due to the scarcity and limited diversity of boron-containing raw materials, the traditional manufacturing process of alkali-free glass is easily restricted by suppliers, which poses significant challenges to the development of the glass fiber sector in China.

In recent years, with the increasing emphasis on environmental protection and low-carbon development, the reduction of boron volatilization during the manufacturing process of alkali-free glass has become particularly important. The reduction of boron volatilization contributes to not only alleviating the environmental compliance pressure on enterprises, but also reducing the emission of solid waste, thereby achieving the environmental protection and promoting the low-carbon development.

Although the boron contents in the existing low-boron-content glass fiber compositions have been controlled at very low levels, both the properties and melting conditions of glass still need to be further optimized. In the prior art, as the boron content decreases, the viscosity of glass increases, but the process window (namely, the difference between the forming temperature and the crystallization temperature) narrows. This phenomenon affects the homogeneity of glass during melting and increases the probability of crystallization of glass fibers during production, thereby raising the difficulty of forming.

Furthermore, when the boron content is reduced, the introduction of alkali metal oxides other than Na₂O and K₂O is an effective solution to address the above issue. However, this solution further leads to the degradation of performance of glass fibers, which compromises the competitiveness of products. The performance degradation makes it fail to meet the development requirements of advanced communication technologies. Therefore, novel low-boron-content glass fiber compositions with optimized properties need to be further explored and developed to adapt to evolving market needs.

### SUMMARY

The technical problem to be solved by the present disclosure is to overcome the deficiencies of the prior art and provide a low-boron-content high-performance alkali-free glass fiber composition. While reducing the boron content, the present disclosure adjusts the glass composition to ensure the stability of melting and forming conditions of the glass fiber composition without compromising the performance of a product of the glass fiber composition, and to enable the improved light transmittance and the reduced dielectric constant.

The present disclosure adopts the following technical solutions:

A low-boron-content high-performance alkali-free glass fiber composition is provided, including the following components in mass percentages: 52% to 60% of SiO₂, 11% to 15% of Al₂O₃, 2% to 6% of B₂O₃, 18% to 25% of CaO, 1% to 3% of MgO, 0.1% to 0.6% of Fe₂O₃, 0.1% to 2.5% of TiO₂, 0.3% to 0.6% of a fluoride, 0.05% to 0.75% of K₂O, 0.05% to 0.75% of Na₂O, and 0.1% to 3% of XO, where the XO includes one or more of FeO, SeO₂, BeO, La₂O₃, and CeO₂.

In the present disclosure, SiO₂ serves as a glass network former. SiO₂ can form an irregular continuous network structure composed of silicon-oxygen tetrahedra. This irregular continuous network structure possesses a high bond strength, and can effectively enhance the mechanical strength, chemical stability, and thermal stability of glass while reducing the density of glass. However, a too-high SiO₂ content will increase the high-temperature viscosity of glass and the difficulty in fiber formation. To satisfy the demands of fiber formation while guaranteeing the desired elastic modulus and density, a mass percentage of the SiO₂ in the glass fiber composition is defined at 52% to 60% in the present disclosure.

Al₂O₃ acts as a glass network intermediate. Al³⁺ can capture non-bridging oxygen to form aluminum-oxygen tetrahedra integrated into a silicon-oxygen network, such that broken networks are reconnected to enhance the compactness of the glass structure, which is conducive to improving the mechanical properties and elastic modulus of glass. However, the introduction of a large amount of Al³⁺ will promote the crystallization tendency of glass. In particular, when a mass percentage of Al₂O₃ is higher than 16%, a significant amount of aluminosilicate particles will be precipitated in glass. To regulate the types of crystallization in glass and reduce the crystallization tendency of aluminosilicates, the mass percentage of Al₂O₃ is defined at 11% to 15% in the present disclosure.

B₂O₃ is a glass network-forming oxide that not only improves a range of properties of glass, but also plays an effective fluxing role. Boron can exist in the form of a [BO₃] triangle and/or a [BO₄] tetrahedron under different conditions. Under high-temperature melting conditions, [BO₄] tetrahedra can hardly be formed, and boron primarily exists in the form of a [BO₃] triangle, which is the main reason why B₂O₃ can reduce the high-temperature viscosity. If a B₂O₃ content is too low, it will be impossible to effectively suppress the crystallization and reduce the viscosity of glass. If the B₂O₃ content is too high, the cost will increase. Therefore, in the present disclosure, a mass percentage of B₂O₃ is defined in a range of 2% to 6%.

CaO is a network modifier oxide, which can reduce the high-temperature viscosity and shorten the working range of glass. The introduction of CaO can increase the crystalline phase competition to effectively suppress the crystallization tendency of aluminosilicates in glass. In the glass system of the present disclosure, CaO significantly increases the density of glass, but has little impact on the elastic modulus of glass. In the present disclosure, a mass percentage of CaO is defined in a range of 18% to 25%.

Unlike CaO, MgO acts as a glass intermediate oxide. Mg²⁺ has a small radius, a high charge density, and strong polarizability. Thus, MgO has a strong aggregation effect, and can increase the degree of polymerization of the glass network. MgO primarily regulates the viscosity of glass, controls the crystallization of glass, and enhances the elastic modulus of glass. However, excessive MgO will increase the maximum crystallization temperature and crystallization rate of glass. In the present disclosure, a mass percentage of MgO is defined in a range of 1% to 3%.

In order to improve the cost-effectiveness of a product on the basis of ensuring the electrical properties of glass, the content of B₂O₃ can be appropriately reduced. The contents of the network former and bridging oxygen in glass can be adjusted to control the competition between boron and silicon ions for oxygen in the structure, thereby reducing the dielectric constant of glass and improving the mechanical properties of glass while taking into account the melting and clarification effects of glass.

CeO₂ and SeO₂ serve as strong oxidizing agents. When heated at high temperatures, CeO₂ and SeO₂ can release oxygen, which promotes the removal of bubbles from a glass melt during a glass melting process. CeO₂ and SeO₂ can regulate a redox atmosphere inside a kiln to effectively control a FeO/Fe₂O₃ ratio, thereby enhancing the thermal conductivity of a glass melt and reducing the energy consumption during a glass melting process. The control of FeO in a glass melt is conducive to stabilizing the temperature of a high-throughput bushing, which facilitates the subsequent fiber drawing operation. According to a fiber drawing operation in a high-modulus kiln, a mass percentage of Fe₂O₃ is controlled at 0.1% to 0.6% in the present disclosure. The use of CeO₂ and SeO₂ can replace sodium sulfate Na₂SO₄ in the traditional formula to reduce the generation of sulfur-containing gases during a melting process in a kiln, minimize the corrosion of sulfur-containing volatile gases to refractory materials, and lower the sulfur content in a flue gas discharged from a kiln. In the glass system of the present disclosure, Se₂O and Ce₂O provide a significant amount of free oxygen. However, excessive Se₂O and Ce₂O not only interfere with the coordination of [AlO₄] and [TiO₄], but also weaken the bridging oxygen in [SiO₄]. As a result, the compactness of the structure is destroyed, the elastic modulus of glass is reduced, and the crystallization is promoted. In addition, the glass is darkened, negating the optimization of glass color.

La³⁺ in La₂O₃ has a large ionic radius and high polarizability, which can enhance the ionic bonding strength in the glass network to enable the formation of a stable structure. This strong bonding can reduce the movement of free charges to lower a dielectric loss. However, excessive La₂O₃ will lead to the aggregation of La³⁺ to disrupt the homogeneity of the glass network structure, cause phase separation or crystallization, and induce localized inhomogeneities, which reduces both the light transmittance and mechanical strength of the material.

BeO, as a high-melting-point oxide (with a melting point of about 2,578 °C), can be integrated into a silicon-oxygen network (Si—O) during glass melting. The strong bonding between Be²⁺ and O²⁻ enhances the compactness of the glass framework. Due to strong polarizability, Be²⁺ can also replace some alkali metal ions (such as Na⁺ or K⁺) in the glass network to form stable local charge compensation, which hinders the long-range diffusion of alkali metal ions and reduces the dielectric constant of glass fibers. However, excessive BeO may lead to the elevation of a melting temperature or the decline in fluidity.

TiO₂ can impart a color to glass during high-temperature melting, which leads to enhanced light scattering, reduced visible light transmittance, and impaired transparency and optical homogeneity of glass. In the present disclosure, a mass percentage of TiO₂ is limited to 0.1% to 2.5%.

Fe₂O₃ is beneficial for the melting of glass and can also improve the crystallization of glass. However, excessive Fe₂O₃ can make glass red or dark-brown. In the present disclosure, a mass percentage of Fe₂O₃ is controlled in a range of 0.1% to 0.6%.

FeO in glass affects the light transmittance and refractive index of glass. The excessive addition of FeO may reduce the light transmittance. FeO can work together with strong oxides to optimize the color of glass and increase the light transmittance of glass.

The fluoride serves as an efficient fluxing agent during a glass melting process. The fluoride can disrupt the silicon-oxygen network structure and significantly lower the melting point and melt viscosity of glass, thereby reducing the energy consumption of melting. At high temperatures, fluoride ions are released and combined with gases (such as CO₂ and SO₂) in a melt, which can accelerate the gas escape and improve the clarification effect and optical purity of glass. However, the excessive addition of the fluoride will result in a high fluoride content in a flue gas discharged from a kiln, which increases the environmental protection cost during a production process. In the present disclosure, a mass percentage of a fluoride is limited to 0.3% to 0.6%.

Preferably, the XO includes the SeO₂, the BeO, the La₂O₃, the CeO₂, and the FeO in a mass ratio of (0-3):(0-15):(0-15):(0-5):1.

Preferably, the XO includes the FeO, the SeO₂, the BeO, the La₂O₃, and the CeO₂.

Preferably, to further ensure the elastic modulus, the impacts of CaO and MgO on the elastic modulus, density, crystallization, and viscosity of glass are comprehensively considered. A ratio of CaO to MgO is adjusted to achieve favorable performance indexes such as high elastic modulus, low density, low crystallization temperature, and low crystallization rate for glass. In the present disclosure, the mass percentage of CaO is limited to 18% to 25%, the mass percentage of MgO is limited to 1% to 3%, and the mass percentages of CaO and MgO are controlled to make a mass ratio of CaO to MgO in a range of (9-12):1.

Both K₂O and Na₂O can break the silicon-oxygen tetrahedral structure of silica (SiO₂) to significantly reduce the melting temperature and viscosity of glass, improve the fluidity of a melt, and shorten the melting time. However, excessive K₂O and Na₂O will increase the number of free Na⁺ and K⁺ ions in glass, making the dielectric constant of glass reduced. Thus, preferably, a total mass percentage of the K₂O and the Na₂O is 0.4% to 0.8%, and a mass ratio of the K₂O to the Na₂O is (0.5-3.5):1.

Preferably, a mass percentage of the B₂O₃ is 3% to 4%.

Preferably, a mass percentage of the MgO is 1.9% to 2.3%.

Preferably, raw materials for preparing the low-boron-content high-performance alkali-free glass fiber composition are pyrophyllite, dolomite, calciborite, limestone, lanthanum hydroxide, phenakite, selenium powder, cerium oxide, and recycled glass powder.

Preferably, raw materials for preparing the low-boron-content high-performance alkali-free glass fiber composition are kaolin, pyrophyllite, dolomite, calciborite, quicklime, lanthanum hydroxide, phenakite, selenium powder, cerium oxide, and recycled glass powder.

Compared with the prior art, the present disclosure has the following beneficial effects:
1. For the low-boron-content high-performance alkali-free glass fiber composition, while reducing the boron content, the present disclosure optimizes and adjusts the glass composition to ensure the stability of melting and forming conditions and enable the superior performance of a product. In addition, SeO₂, BeO, La₂O₃, and CeO₂ are introduced to effectively improve the light transmittance of glass fibers, reduce the dielectric constant of glass fibers, increase the elastic modulus of glass fibers, and enhance the adaptability of glass to different application scenarios.
2. If raw materials selected for producing the low-boron-content high-performance alkali-free glass fiber composition in the present disclosure are not thoroughly mixed, quartz powder cannot be melted in time during a glass melting process, which deteriorates the melting quality of glass and adversely affects the quality of a product. As a result, in the present disclosure, quartz powder is not used, which can enhance the melting of raw materials, reduce the energy consumption, and lower the carbon emission.
3. For the low-boron-content high-performance alkali-free glass fiber composition of the present disclosure, the use of boron-containing raw materials is reduced, such that the volatilization of boron-containing substances during a melting process is alleviated, which contributes to environmental protection cost reduction and environmental protection.
4. Low-boron-content high-performance alkali-free glass fibers produced from the low-boron-content high-performance alkali-free glass fiber composition of the present disclosure have a melting temperature of not higher than 1,470 °C, a liquidus temperature of not higher than 1,100 °C, and a low crystallization rate, which meet the requirements of a fiber drawing process. Therefore, the low-boron-content high-performance alkali-free glass fiber composition is suitable for tank furnace-based large-scale production.

### DETAILED DESCRIPTION OF THE EMBODIMENTS

To enable those skilled in the art to well understand the technical solutions in the present disclosure, the technical solutions of the present disclosure will be clearly and completely described below with reference to the embodiments of the present disclosure.

In the following embodiments, when low-boron-content high-performance alkali-free glass fibers are prepared from a low-boron-content high-performance alkali-free glass fiber composition, a tank furnace-based fiber drawing process is adopted, including the following steps:
(1) A required mass of each raw material is calculated based on a content of each component in the low-boron-content high-performance alkali-free glass fiber composition. Then, raw materials are taken using a raw material batching system according to a set ratio, thoroughly mixed through pneumatic mixing, delivered to a furnace feed hopper, and uniformly fed into a large-scale tank furnace by a feeder.
(2) A thoroughly mixed material is melted at 1,425 °C in the large-scale tank furnace and clarified to produce a homogeneous glass melt.
(3) The glass melt flows through a furnace forehearth to a platinum-rhodium bushing. Glass fibers with different diameters are drawn at 1,230 °C through nozzles of the platinum-rhodium bushing.
(4) The glass fibers are pulled to a drawing machine and subjected to high-speed drawing to produce a precursor fiber product.

### Examples 1 to 11 and Comparative Examples 1 to 9

Formulas for alkali-free glass fiber compositions in Examples 1 to 11 and Comparative Examples 1 to 9 are shown in Tables 1 to 2. Impurities are inevitably introduced. The balance in each composition represents an amount of impurities introduced, which is not reflected in Tables 1 to 2.

Table 1 Formulas for alkali-free glass fiber compositions in Examples 1 to 10

| Components and | Example | Example | Example | Example | Example | Example | Example | Example | Example | Example |
|---|---|---|---|---|---|---|---|---|---|---|
| properties | 1 | 2 | 3 | 4 | 5 | 6 | 7 | 8 | 9 | 10 |
| SiO₂ | 55.48 | 55.45 | 55.43 | 55.82 | 56.06 | 53.58 | 55.86 | 54.9 | 54.96 | 54.7 |
| Al₂O₃ | 14.48 | 14.4 | 13.9 | 14.03 | 14.05 | 14.8 | 13.7 | 14 | 13.5 | 13.33 |
| B₂O₃ | 4.3 | 4.52 | 4.2 | 3.5 | 3.62 | 5.33 | 5.15 | 4.13 | 3.9 | 4.25 |
| CaO | 21.9 | 21.78 | 22.44 | 22.58 | 22.24 | 22 | 21.4 | 22.4 | 23.05 | 22.81 |
| MgO | 2 | 1.9 | 2.05 | 2.1 | 2.15 | 2.2 | 1.9 | 2 | 2.3 | 2.3 |
| Fe₂O₃ | 0.283 | 0.282 | 0.277 | 0.29 | 0.28 | 0.27 | 0.17 | 0.3 | 0.29 | 0.25 |
| TiO₂ | 0.26 | 0.26 | 0.24 | 0.24 | 0.24 | 0.25 | 0.25 | 0.25 | 0.27 | 0.27 |
| Fluoride | 0.53 | 0.52 | 0.57 | 0.57 | 0.5 | 0.57 | 0.52 | 0.4 | 0.5 | 0.5 |
| K₂O | 0.32 | 0.23 | 0.32 | 0.33 | 0.32 | 0.32 | 0.35 | 0.22 | 0.36 | 0.36 |
| Na₂O | 0.32 | 0.45 | 0.45 | 0.41 | 0.4 | 0.32 | 0.19 | 0.28 | 0.38 | 0.38 |
| FeO | 0.1 | 0.1 | 0.1 | 0.1 | 0.1 | 0.1 | 0.1 | 0.1 | 0.13 | 0.13 |
| SeO₂ | — | — | — | — | — | 0.2 | 0.2 | — | — | — |
| BeO | — | — | — | — | — | — | — | 1 | — | — |
| CeO₂ | — | — | — | — | — | — | 0.2 | — | — | — |
| La₂O₃ | — | — | — | — | — | — | — | — | 0.25 | 0.5 |
| Elastic modulus (GPa) | 80.5 | 81.3 | 81 | 82.3 | 82 | 81 | 81 | 81.5 | 81.5 | 81.8 |
| Light transmittance (%) | 88.5 | 89 | 89.5 | 89.9 | 90 | 91 | 91.2 | 89 | 89.1 | 89.5 |
| Dielectric constant | 6.7 | 6.69 | 6.69 | 6.7 | 6.72 | 6.65 | 6.65 | 6.6 | 6.65 | 6.6 |
| Melting temperature/°C | 1427 | 1426 | 1424 | 1426 | 1426 | 1424 | 1425 | 1426 | 1427 | 1427 |
| Maximum crystallization | 1100 | 1099 | 1099 | 1100 | 1100 | 1100 | 1099 | 1100 | 1100 | 1100 |
| temperature/°C | | | | | | | | | | |

Table 2 Formulas for alkali-free glass fiber compositions in Example 11 and Comparative Examples 1 to 9

| Components and | Example | Comparative | Comparative | Comparative | Comparative | Comparative |
|---|---|---|---|---|---|---|
| properties | 11 | Example 1 | Example 2 | Example 3 | Example 4 | Example 5 |
| SiO₂ | 54.57 | 54.02 | 54.57 | 54.57 | 54.15 | 54.57 |
| Al₂O₃ | 13.77 | 13.12 | 13.32 | 13.52 | 13.2 | 13.52 |
| B₂O₃ | 3.82 | 3.82 | 3.82 | 3.82 | 3.82 | 3.82 |
| CaO | 22.48 | 22.08 | 22.48 | 22.48 | 22.17 | 22.48 |
| MgO | 2.3 | 2.1 | 2.2 | 2.3 | 2.3 | 2.2 |
| Fe₂O₃ | 0.2 | 0.2 | 0.2 | 0.2 | 0.2 | 0.2 |
| TiO₂ | 0.27 | 0.27 | 0.27 | 0.27 | 0.27 | 0.27 |
| Fluoride | 0.42 | 0.42 | 0.42 | 0.42 | 0.42 | 0.42 |
| K₂O | 0.26 | 0.26 | 0.26 | 0.26 | 0.26 | 0.26 |
| Na₂O | 0.28 | 0.28 | 0.28 | 0.28 | 0.28 | 0.28 |
| FeO | 0.08 | 0.08 | 0.08 | 0.08 | 0.08 | 0.08 |
| SeO₂ | 0.2 | 0.3 | 0.2 | 0.2 | 0.2 | 0.5 |
| BeO | 0.75 | 1.25 | 1.3 | 0.75 | 0.75 | 0.75 |
| CeO₂ | 0.2 | 1.25 | 0.2 | 0.2 | 1.5 | 0.2 |
| La₂O₃ | 0.35 | 0.5 | 0.35 | 0.6 | 0.35 | 0.35 |
| Elastic modulus | 83 | 78.5 | 80 | 80.3 | 77 | 79 |
| (GPa) | | | | | | |
| Light transmittance | 91.5 | 87.3 | 89.4 | 79.8 | 75 | 75 |
| (%) | | | | | | |
| Dielectric constant | 6.55 | 6.7 | 6.65 | 6.73 | 6.7 | 6.75 |
| Melting | 1426 | 1440 | 1430 | 1429 | 1424 | 1426 |
| temperature/°C | | | | | | |
| Maximum | 1099 | 1110 | 1105 | 1105 | 1102 | 1102 |
| crystallization | | | | | | |
| temperature/°C | | | | | | |

| Components and | Comparative | Comparative | Comparative | Comparative |
|---|---|---|---|---|
| properties | Example 6 | Example 7 | Example 8 | Example 9 |
| SiO₂ | 54.92 | 54.67 | 54.47 | 54.2 |
| Al₂O₃ | 13.62 | 13.77 | 13.77 | 14.4 |
| B₂O₃ | 3.82 | 3.82 | 3.82 | 6.3 |
| CaO | 20.58 | 22.62 | 22.38 | 22.7 |
| MgO | 4 | 2.3 | 2.3 | 0.58 |
| Fe₂O₃ | 0.2 | 0.2 | 0.2 | 0.291 |
| TiO₂ | 0.27 | 0.27 | 0.27 | 0.25 |
| Fluoride | 0.42 | 0.42 | 0.42 | 0.5 |
| K₂O | 0.26 | 0.15 | 0.15 | 0.29 |
| Na₂O | 0.28 | 0.15 | 0.6 | 0.32 |
| FeO | 0.08 | 0.08 | 0.08 | 0.15 |
| SeO₂ | 0.2 | 0.2 | 0.2 | — |
| BeO | 0.75 | 0.75 | 0.75 | — |
| CeO₂ | 0.2 | 0.2 | 0.2 | — |
| La₂O₃ | 0.35 | 0.35 | 0.35 | — |
| Elastic modulus | 78 | 80.1 | 80.1 | 79.2 |
| (GPa) | | | | |
| Light transmittance | 91.2 | 91 | 91.1 | 88.8 |
| (%) | | | | |
| Dielectric constant | 6.75 | 6.68 | 6.8 | 6.7 |
| Melting | 1445 | 1439 | 1435 | 1426 |
| temperature/°C | | | | |
| Maximum | 1112 | 1113 | 1105 | 1100 |
| crystallization | | | | |
| temperature/°C | | | | |

As shown in Tables 1 and 2, compared with glass fibers produced with the traditional high-boron-content glass formula of Comparative Example 9, glass fibers produced from the glass fiber compositions of Examples 1 to 5 all do not deteriorate in terms of an elastic modulus, a light transmittance, a dielectric constant, a melting temperature, and a maximum crystallization temperature (the maximum crystallization temperature is a key parameter indicating the transition of a glass material from an amorphous state (disordered structure) to a crystalline state (ordered structure), and during glass melting, the lower the maximum crystallization temperature, the better). Compared with glass fibers produced with the traditional high-boron-content glass formula of Comparative Example 9, glass fibers produced from the glass fiber compositions of Examples 6 to 11 are improved to some extent in terms of both the light transmittance and dielectric constant.

According to Comparative Examples 1 to 5, when XO includes SeO₂, BeO, La₂O₃, CeO₂, and FeO simultaneously, but a mass ratio thereof does not fall in the range of (0-3):(0-15):(0-15):(0-5):1 specified in the present disclosure, all properties of glass deteriorate to varying degrees, except that the dielectric constant remains unchanged. This is mainly because SeO₂ and CeO₂ provide a significant amount of free oxygen. Excessive SeO₂ and CeO₂ not only interfere with the coordination of [AlO₄] and [TiO₄], but also weaken the bridging oxygen in [SiO₄]. As a result, the compactness of the structure is destroyed, the elastic modulus of glass is reduced, and the crystallization is promoted. In addition, the glass is darkened, negating the optimization of glass color. Excessive BeO may lead to the elevation of a melting temperature or the decline in fluidity. Excessive La₂O₃ will lead to the aggregation of La³⁺ to disrupt the homogeneity of the glass network structure, cause phase separation or crystallization, and induce localized inhomogeneities, which reduces both the light transmittance and mechanical strength of the material. Consequently, the mass ratio of FeO, SeO₂, BeO, La₂O₃, and CeO₂ should be controlled within a reasonable range.

According to Comparative Example 6, if the content of MgO is too high, the content of CaO is too low, and the mass ratio of CaO to MgO is not in the range of (9-12):1 specified in the present disclosure, the maximum crystallization temperature of glass will increase significantly and the melting temperature of glass will also increase, leading to increased difficulty in glass melting.

According to Comparative Examples 7 and 8, if the contents of K₂O and Na₂O are too low or the mass ratio of K₂O to Na₂O is not in the range of (0.5-3.5):1 specified in the present disclosure, the maximum crystallization temperature of glass will increase significantly and the melting temperature of glass will also increase, leading to increased difficulty in glass melting.

What is claimed is:

1. A low-boron-content high-performance alkali-free glass fiber composition, comprising the following components in mass percentages: 52% to 60% of SiO₂, 11% to 15% of Al₂O₃, 2% to 6% of B₂O₃, 18% to 25% of CaO, 1% to 3% of MgO, 0.1% to 0.6% of Fe₂O₃, 0.1% to 2.5% of TiO₂, 0.3% to 0.6% of a fluoride, 0.05% to 0.75% of K₂O, 0.05% to 0.75% of Na₂O, and 0.1% to 3% of XO, wherein the XO comprises one or more of FeO, SeO₂, BeO, La₂O₃, and CeO₂.

2. The low-boron-content high-performance alkali-free glass fiber composition according to claim 1, wherein the XO comprises the SeO₂, the BeO, the La₂O₃, the CeO₂, and the FeO in a mass ratio of (0-3):(0-15):(0-15):(0-5):1.

3. The low-boron-content high-performance alkali-free glass fiber composition according to claim 1, wherein the XO comprises the FeO, the SeO₂, the BeO, the La₂O₃, and the CeO₂.

4. The low-boron-content high-performance alkali-free glass fiber composition according to claim 1, wherein a mass ratio of the CaO to the MgO is (9-12):1.

5. The low-boron-content high-performance alkali-free glass fiber composition according to claim 1, wherein a total mass percentage of the K₂O and the Na₂O is 0.4% to 0.8%, and a mass ratio of the K₂O to the Na₂O is (0.5-3.5):1.

6. The low-boron-content high-performance alkali-free glass fiber composition according to claim 1, wherein a mass percentage of the B₂O₃ is 3% to 4%.

7. The low-boron-content high-performance alkali-free glass fiber composition according to claim 1, wherein a mass percentage of the MgO is 1.9% to 2.3%.

8. The low-boron-content high-performance alkali-free glass fiber composition according to claim 1, wherein raw materials for preparing the low-boron-content high-performance alkali-free glass fiber composition are pyrophyllite, dolomite, calciborite, limestone, lanthanum hydroxide, phenakite, selenium powder, cerium oxide, and recycled glass powder.

9. The low-boron-content high-performance alkali-free glass fiber composition according to claim 1, wherein raw materials for preparing the low-boron-content high-performance alkali-free glass fiber composition are kaolin, pyrophyllite, dolomite, calciborite, quicklime, lanthanum hydroxide, phenakite, selenium powder, cerium oxide, and recycled glass powder.
